(19) United States
(12) Patent Application Publication
(10) Pub. No.: US 2006/0213111 A1
(43) Pub. Date: Sep. 28, 2006

(54) Fishing jig

(75) Inventor: Robert J. Mitchell, Phoenix, AZ (US)

Correspondence Address: John D. Titus;The Cavanagh Law Firm, Ste. 2400, 1850 N. Central Avenue, Phoenix, AZ, 85004, US

(73) Assignee: Jumping Cholla LLC, Phoenix,, AZ (US)

(21) Appl. No.: 11/088,532

(22) Filed: Mar. 24, 2005

(51) Int. Cl. A01K 85/00; A01K 83/00

(52) U.S. Cl. 43/42.39; 43/44.81; 43/44.82

(57) ABSTRACT

A multiple hook fishing lure has three hooks, the shank portions of which extend in a parallel spaced-apart configuration from a weighted head member. In a preferred embodiment, the shank members lie in a common plane with the outer most two hook members also lying in the same plane. The hook portion of the central hook and the eyelet lie in a second plane that is substantially normal to the plane of the shank members. The three hooks are capable of flexing independently from each other. Accordingly, the fishing jig is set more easily and is more difficult for the fish to throw.

### BACKGROUND OF THE INVENTION

The present invention relates generally to fishing lures, more specifically, to weighted fish hooks often referred to as fishing jigs.

Artificial lures are man made objects used by sport fishermen to attract sport fish and entice them to bite a hook that is embedded in or attached to the lure. The majority of artificial lures are designed to imitate some sort of natural prey of the sport fish, however, some simply mimic an action that triggers a feeding response or other instinct that causes the fish to strike. Lures are manufactured in many shapes, sizes and styles and are constructed from a variety of materials including plastic, metal, feathers and string.

One popular lure is known as a jig. A jig consists essentially of a hook, a weighted head attached to the shank portion of the hook and an eyelet for securing the jig to a fishing line. The jig may be rigged in many different configurations, however, the most popular is to engage a soft plastic worm or other artificial lure over the shank portion of the hook. The weighted head of the jig serves a functional purpose as a sinker as well as providing a more life-like appearance to the rig. As it is commonly understood in the art, a lure must be provided with a certain amount of weight so that it is capable of being cast and will sink to the appropriate depth. When fishing with a jig, the fisherman creates the action of the lure in the water. Some fish such as bass are attracted to a crayfish assuming a defensive posture with claws raised or making a break for cover. Consequently, bass will often strike a jig that has been fouled on rocks or weeds just as the jig is freed from the obstruction. Crappie, on the other hand, instinctively strike at a jig moving past them at a steady speed at the appropriate range.

U.S. Pat. No. 4,998,373 to Braswell discloses a double-hook jig comprising a weighted head with eyelet and a pair of hooks that diverge outwardly from the weighted head. The ends of the hooks are then bent parallel to the axis of the weighted head. According to the inventor, the parallel hook configuration is optimal for hooking fish that strike the lure, particularly those fish striking from behind. U.S. Pat. No. 5,339,559 discloses a jig comprising a weighted head with eyelet, a single hook and a rubber band for retaining bait on the hook. U.S. Pat. No. 5,537,775 discloses a jig in which the weighted head is removable from the hook and eyelet portions of the jig.

As most sport fisherman know, crappie and other sport fish are quite capable of striking, then throwing the hook before the angler has an opportunity to set the hook to catch the fish. As noted in U.S. Pat. 4,998,373, conventional multiple hook jigs tend to pivot in relation to the rest the rest of the line. A fish striking a line having a conventional double or triple hook is often able to throw the hook by pivoting it with respect to the line. Accordingly, what is needed is a fishing jig having multiple hooks with parallel flexible shanks that cause the hooks to be set rather than being thrown by the fish as it pivots in an attempt to throw the hook.

### SUMMARY OF THE INVENTION

The present invention comprises a multiple hook fishing lure having three hooks, the shank portions of which extend in a parallel spaced-apart configuration from a weighted head member. In a preferred embodiment, the shank members lie in a common plane with the outer most two hook members also lying in the same plane. The hook portion of the central hook and the eyelet lie in a second plane that is substantially normal to the plane of the shank members. By providing three hooks that flex independently from each other, the fishing jig of the present invention is set more easily and is more difficult for the fish to throw than prior art fishing jigs.

### BRIEF DESCRIPTION OF THE DRAWING

The present invention will be better understood from a reading of the following detailed description, taken in conjunction with the accompanying drawings figures in which like references designate like elements and, in which:

FIG. 1 is a perspective view of a prior art jig lure;

FIG. 2 is a perspective view of a fishing lure incorporating features of the present invention;

FIG. 3 is a side cross-sectional view of the fishing lure of FIG. 2;

FIG. 4 is a top cross-sectional view of the fishing lure of FIG. 2;

FIG. 5 is a perspective view of an alternative embodiment of a fishing lure incorporating features of the present invention; and

FIG. 6 is an end view of another alternative embodiment of a fishing lure incorporating features of the present invention.

### DETAILED DESCRIPTION

The drawing figures are intended to illustrate the general manner of construction and are not necessarily to scale. In the detailed description and in the drawing figures, specific illustrative examples are shown and herein described in detail. It should be understood, however, that the drawing figures and the detailed description are not intended to limit the invention to the particular form disclosed, but are merely illustrative and intended to teach one of ordinary skill how to make and/or use the invention claimed herein and for setting forth the best mode for carrying out the invention.

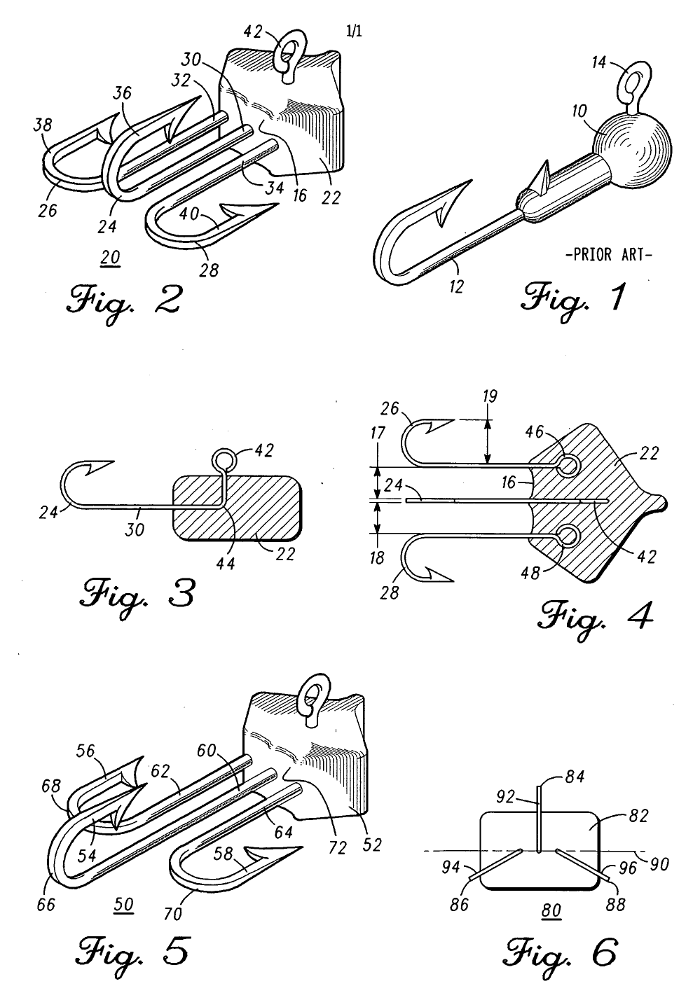

As noted hereinbefore, one of the more popular types of fishing lures is the jig. As shown in FIG. 1, the essential components of a jig are the weighted head 10, the hook 12 which protrudes from the weighted head and the eyelet 14, for securing the jig to a fishing line. A conventional jig is typically rigged with a soft plastic worm or other artificial bait over hook 12. As can be observed from the configuration of the prior art jig, a fish that strikes hook 12 from behind can easily throw the hook by pivoting downwards causing the hook to rotate downward relative to eyelet 14.

With reference to FIGS. 2-4, a fishing lure 20 incorporating features of the present invention comprises a weighted head 22, a first hook member 24, second hook member 26 and third hook member 28, each of which extends outward from weighted head 22. First hook member 24, second hook member 26 and third hook member 28 each comprise shank portions 30, 32 and 34 respectively and terminate in curved hook portions 36, 38 and 40 respectively.

Shank portions 30, 32 and 34 lie in a substantially common plane (i.e., within +/−10° of planar, preferably within +/−5° of planar and most preferably +/−2° of planar). Shank portions 30, 32 and 34 are also substantially parallel to each other (i.e., within +/−10° of parallel, preferably +/−5° of parallel and most preferably +/−2° of parallel). In the embodiment of FIG. 2, curved hook portions 38 and 40 also lie in the plane common with shank portions 30, 32 and 34, while curved hook portion 36 lies in a plane substantially normal to the plane containing shank portions 30, 32 and 34. Curved hook portions 36, 38, and 40 all extend approximately the same distance from lower surface 16 of weighted head member 22.

With particular reference to FIGS. 3 and 4, first hook member 24, second hook member 26 and third hook member 28 are of substantially conventional construction being formed from a hardened steel wire or other suitable material having a high tensile strength and a high yield point such that the hook members themselves are substantially rigid, yet flexible. Eyelet 42 is formed as an extension of shank 30 of first hook member 24, which is formed by making a 90° bend 44 in shank portion 30. Hook members 26 and 28 also include eyelets 46 and 48 however, eyelets 46 and 48 are embedded in weighted head 22, which itself is formed by casting molten lead around hook members 24, 26 and 28 in the form of a quasi-pentagonal solid prism as shown in FIG. 4. The quasi-pentagonal solid prism shape of weighted head 22 assists in reducing snags as the jig is moved forward by deflecting the side hooks. Although in the illustrative embodiment, weighted head member 22 is cast lead, other materials having the appropriate weight and strength such as die cast zinc alloys, thermoset plastics, high strength thermoplastics, or other materials having the appropriate weight and strength to retain embedded eyelets 46 and 48 are considered within the scope of the present invention.

As is well known in the art, fishing jigs are made in various sizes, with the hook size and the size of the weighted head being changed in order to target different species of fish and to accommodate different sizes of bait. Accordingly, the distance 17 between shank portions 30 and 32 and the distance 18 between shank portions 30 and 34 vary with the absolute size of the fishing lure 20. Preferably, the distance 17 and the distance 18 is from 10% to 60% and most preferably from 20% to 40% of the throat dimension 19 of curved hook portions 32, 34 and 36 of hook members 24, 26, and 28. Similarly, the lengths of shank portions 30, 32 and 34 that extend out of weighted head 22 vary with the absolute size of the fishing jig. Preferably at least 70% of the straight portion of shank portions 30, 32, and 34 extend outside of weighted head 22 (i.e. no more than 30% of the shank portions are embedded in weighted head 22). Most preferably, at least 85% of the straight portion of shank portions 30, 32, and 34 extend outside of weighted head 22 (i.e. no more than 15% of the shank portions are embedded in weighted head 22).

With reference to FIG. 5, an alternative embodiment of a fishing lure 50 incorporating features of the present invention comprises a weighted head 52, a first hook member 54, a second hook member 56 and a third hook member 58, extending outward from weighted head 52. First hook member 54, second hook member 56 and third hook member 58 comprise shank portions 60, 62 and 64 and curved hook portions 66, 68 and 70 respectively. Shank portions 60, 62 and 64 are substantially and in a substantially common plane that also includes curved hook portions 68 and 70. Curved hook portion 66 lies in a plane that is substantially normal to the plane containing shank portions 60, 62 and 64. Curved hook portions 68 and 70 extend approximately the same distance from lower surface 72 of weighted head 52. Curved hook portion 66, however, extends beyond curved hook portions 68 and 70, with shank portion 60 being preferably from 10 to 30% longer than shank portions 62 and 64.

With reference to FIG. 6, another alternative embodiment of a fishing lure 80 incorporating features of the present invention comprises a weighted head 82, a first hook member 84, a second hook member 86 and a third hook member 88 which extend outward from weighted head 82. As with the previous embodiments, the shank portions of first hook member 84, second 86 and third hook member 88 all lie in substantially a common plane 90 as shown in FIG. 6. Unlike the prior embodiments, however, curved hook portions 92, 94 and 96 all lie outside the plane 90 containing the shank portions of first hook member 84, second hook member 86 and third hook member 88.

By providing a fishing jig having a weighted head with three hook members extending such that their shanks are in a substantially parallel spaced-apart configuration, a fishing lure incorporating features of the present invention provides an artificial lure that is highly effective for its intended purpose. The three hook configuration increases the probability of hooking the fish while at the same time the parallel shanks allow the hooks to flex independently of each other thereby significantly decreasing the probability of a thrown hook, for the motion that would tend to throw one hook only results in the other hooks being set into the fish.

Although certain illustrative embodiments and methods have been disclosed herein, it will be apparent from the foregoing disclosure to those skilled in the art that variations and modifications of such embodiments and methods may be made without departing from the spirit and scope of the invention. Accordingly, it is intended that the invention should be limited only to extent required by the appended claims and the rules and principals of applicable law.

1. A fishing lure comprising:
a first hook member, said first hook member comprising a substantially rigid wire element formed into a first curved hook portion, a first shank portion and a first tip end;
a second hook member, said second hook member comprising a substantially rigid wire element formed into a second curved hook portion, a second shank portion and a second tip end;
a third hook member, said third hook member comprising a substantially rigid wire element formed into a third curved hook portion, a third shank portion and a third tip end; and
a weighted head member rigidly joining together said first, second and third tip ends of said first hook member, said second hook member and said third hook member such that the said first, second and third shank portions are maintained in a juxtaposed, substantially parallel, spaced-apart configuration.

2. The fishing lure of claim 1, wherein:
said weighted head member is solid.

3. The fishing lure of claim 1, wherein:
said head member comprises a quasi-pentagonal solid prism.

4. The fishing lure of claim 1, wherein:
said first, second and third shank portions lie substantially in a common first plane.

5. The fishing lure of claim 1, wherein:
said first hook member includes an eyelet.

6. The fishing lure of claim 4, wherein:
said first hook member includes an eyelet.

7. The fishing lure of claim 6, wherein;
said eyelet extends in a direction out of the common first plane.

8. The fishing lure of claim 4, wherein:
said second hook portion and said third hook portion lie substantially in said common first plane.

9. The fishing lure of claim 8, wherein:
said first hook portion lies in a second plane substantially normal to said common first plane.

10. The fishing lure of claim 1, wherein:
said first and second shank portions lie in a first plane;
said second and third shank portions lie in a second plane; and
said first and third shank portions lie in a third plane, wherein said first, second, and third planes intersect along parallel lines.

11. The fishing lure of claim 10, wherein:
said weighted head member is solid.

12. The fishing lure of claim 10, wherein:
said head member comprises a quasi-pentagonal solid prism.

13. The fishing lure of claim 10, wherein:
said first hook member includes an eyelet

14. The fishing lure of claim 13, wherein;
said eyelet lies in a plane substantially normal to said second plane.

15. The fishing lure of claim 1 wherein;
said third hook member is between said first hook member and said second hook member and said third hook member extends at least as far from said head member as said first hook member and said second hook member.

16. The fishing lure of claim 1 wherein;
said first hook member, said second hook member and said third hook member have curved hook portions that are substantially equal in radius.
